(19) United States
(12) Patent Application Publication
(10) Pub. No.: US 2012/0307015 A1
(43) Pub. Date: Dec. 6, 2012

(54) Device for Positioning and Calibrating at Least Two Cameras with a Partial Mirror to Take Three-Dimensional Pictures

(76) Inventor: Florian MAIER, Gilching (DE)

(21) Appl. No.: 13/415,678

(22) Filed: Mar. 8, 2012

Related U.S. Application Data
(63) Continuation of application No. PCT/DE2010/001052, filed on Sep. 6, 2010.

(30) Foreign Application Priority Data
Sep. 8, 2009 (DE) 10 2009 040 530.5

(51) Int. Cl. H04N 13/02

(52) U.S. Cl. 348/47; 348/E13.074

(57) ABSTRACT

The invention is directed to a device with which beam paths of at least two cameras mounted on a supporting frame are merged through a partial mirror to take three-dimensional pictures, wherein the partial mirror is preferably fixed to a mirror box and the mirror box is movable on guides associated with the supporting frame, and whereby the height of the optical axis of the camera(s) whose beam paths are being partly reflected in the mirror is adjustable. A first embodiment includes a device wherein the partial mirror is moveable about three axes. A second embodiment includes a device having a photo sensor in the camera and/or an optical compensation element arranged between or in the lens, and the photo sensor is adjustable. A third embodiment includes a device wherein only partial image areas can be read out from an image sensor.

The invention concerns a device for positioning and calibrating at least two cameras with a partial mirror to take three-dimensional pictures.

### BACKGROUND

Taking pictures that appear three-dimensional requires at least two views of the object being photographed. These views are usually only distinguished by a small change to the angle of vision. These small changes to the angle of vision can usually not be obtained simply by positioning the cameras next to each other since the camera bodies and/or the lenses are too big for the cameras to be positioned close enough to each other. Here the camera bodies would literally have to be able to overlap, which is physically impossible. A special device is therefore being used particularly in the film area that joins the beam path of at least two cameras through a partial mirror, so that the beam paths of both cameras can overlap without the bodies and/or the lenses disturbing each other (see literature: Lipton, Lenny: Foundations of the Stereoscopic Cinema; A Study in Depth, Van Nostrand Reinhold Company, 1982). These devices are usually not equipped with always the same type of camera, but rather with different types of cameras and/or lenses depending on the assignment and the preference of the user. Since the cameras and the lenses of these apparatuses that are being used simultaneously to take three-dimensional pictures actually never have exactly the same geometrical properties (e.g. because of production tolerances)—this particularly applies to zoom lenses—a calibrated camera mounting for taking photos (e.g. through parallel optical axes on a horizontal level) is never actually given. This means that the positions of the beam paths have to be matched with each other to avoid errors such as a parallax in altitude or diverging optical axes.

It is a well-known fact that this alignment can either be carried out at the camera itself through a positioning device or by tilting or moving a mirror that can be adjusted independently in a so-called mirror box with the mirror box being firmly fixed to the remainder of the camera mounting. The disadvantage of the first method is that especially with heavy cameras it requires a very expensive, robust, exact and sophisticated positioning technology that has an adverse effect on the total weight of the apparatus. A disadvantage of the second method is that it also requires a very robust, exact, heavy and partly complicated technology to be able to actually install the mirror vibration-free, something that has previously not been done successfully. Particularly the vibration-free feature is a very important aspect especially since low frequency sound waves (e.g. during Live-concerts) or jolts (with a corresponding movement of the complete device) can lead to jolts and thus to a camera shake of only one picture (i.e. the one that is being reflected). This greatly disturbs the three-dimensional impression. Another disadvantage is that by using this method, a lot of valuable space at the side of the mirror box is lost. This greatly restricts the lens's wide-angle properties. Likewise, an exact tilting is also not very easy to achieve.

### BRIEF DESCRIPTION OF THE DRAWINGS

FIG. 1 shows that in a non calibrated position of the device there is a height difference between the optical axes of camera (1)—reflected in the partial mirror (3)—and the optical axes of camera (2)—going through the partial mirror (3).

FIG. 2 shows that by moving mirror box (4) with the fixed partial mirror (3) horizontally towards the fixed supporting frame (5) and the camera (2), the height difference existing in FIG. 1 between both optical axes can be compensated, so that the optical axes of both cameras (1) and (2) are in the same horizontal plane.

### DETAILED DESCRIPTION

Turning then to the several Figures wherein like numerals indicate like parts, both figures show a device with which beam paths of two cameras (1) and (2) mounted on a supporting frame (5) are merged through a partial mirror (3) to take three-dimensional pictures. The device is characterised by the partial mirror (3) being fixed to a mirror box (4) and the mirror box (4) being able to be moved on guides on the supporting frame (5) horizontally to adapt the height of the optical axis of the camera (1) whose beam path is being reflected in the partial mirror (3) in relationship to the optical axis of camera (2) whose beam path goes through the partial mirror (3).

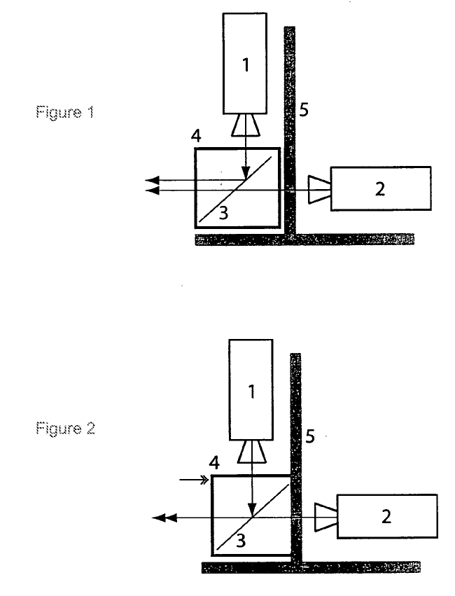

With respect to the deficiencies in the prior art as noted above, a first possible solution (see FIGS. 1 and 2) calls for the rigid and vibration-free installation of a partial mirror (3) in a mirror box (4) that has been translationally (horizontally or vertically) installed on to the complete device (5). To allow the beam path of the mirrored camera (1) to be set at the height of the beam path of the camera that is looking through the mirror (2), the box (4) can be adjusted on guides. This adjustment can also be carried by a motor through a spindle-supported or similarly supported device.

A second possible solution calls for a firm fixation at a minimum of three corners of the mirror (2). Directed movements of at least one of the corners will lead to a slight tilting of the mirror (2) either around the horizontal axis, the vertical axis or the diagonal axis. Alternatively, the opposite corners can also be moved in the opposite direction. To adjust the height, all corners can be simultaneously moved in one direction. This can be done, for example, through a ball-joint arrangement of the bearings of each corner with a precisely positioned motor drive with a magnetic adjustment also being conceivable.

A third possible solution calls for a horizontal and/or vertical movement or rotational movement (can also be eccentric) of the photo sensor (not shown) in one or several cameras instead of or in addition to the adjustment of the mirror (2) or another adjustment. Instead of or in addition to this, an adjustable and, if need be, an electronically controllable, optical element can be used to compensate for the calibration. Here the sensor or the optical element is very precisely triggered either by the operating elements at the camera or cable or by manual radio control or automatically from a computer unit thereby, for example, replacing a tilting of the mirror or a camera, or a rotating of a mirror or the rotating of a camera. The advantage of this method is that particularly the horizontal correction is a compensation operation that does not produce any geometrical distortions (Keystone-Distortion—see literature: Lipton, Lenny: Foundations of the Stereoscopic Cinema; A Study in Depth, Van Nostrand Reinhold Company, 1982), as would be the case if the camera were to be positioned by rotating it (convergence setting). Also, compared with moving the individual pictures to one another, by moving the sensor or by adapting the optical element no clippings will arise at the edges of the pictures later during the finishing process (positioning the so-called screen plane in the finishing process)—see literature: Kuhn, Gerhard: Stereofotografie und Raumbildprojektion, vfv Verlag für Foto, Film und Video, Gilching 1999). Piezo elements or delicate multiphase motors or magnetic linear motors can perform this movement of the sensor or the optical element.

A fourth possible solution calls for a large image converter (e.g. CMOS) that can also be read out in only partial image areas or in a contiguous rectangular image area, whereas the area that has been read out is either read out horizontally, and/or vertically, and/or diagonally and/or displaced in rotation according to the calibrated values, whereby the whole area does not necessarily have to be recorded, which helps to save band width and data amounts. Thus, for example, a 2 k sensor (2048 pixels horizontal resolution) can be read out with only Full-HD (1920 pixels horizontal resolution), whereas with a horizontal movement 128 pixels would be available for correction purposes or to adapt the screen plane. Much better alternatives would of course be available through higher resolutions (5 k sensor, but only 4 k recording).

Solutions three and four can also be combined with each other as well as with solutions one or two.

A tilting device of the camera around the horizontal and/or vertical and/or diagonal and/or optical axis and/or an adjustment of the height can make all the required adjustments that have not been covered by one of the above alternatives.

To keep a camera mounting with at least two cameras in balance at all times, invention embodiments include a counterbalance adjustment that allows the cameras to be moved from the centre of gravity of the apparatus in the respectively opposite direction on their own two respective guides. The synchronous movement at both sides can take place through a mechanical coupling (e.g. a belt drive with or without a motor drive) or by at least two synchronised motors that move the carriages, e.g. simultaneously to the respectively opposite side by using spindles. To be able to counterbalance the centre of gravity again when any additional extensions are being mounted on the device, a mechanical coupling device provides a coupling for moving at least only one camera whereby at least one other camera remains motionless until the system is balanced. After that the connection is re-established. This can also be done electronically by intelligently triggering the motors through a coupling with a belt drive as well as with a bi-motored control.

The device can also include adjusting mechanisms for setting camera distance from the mirror box (4z). Here such camera, including any possible adjustment elements used for calibration purposes, is assembled on a carrier (either with the help of a guide, e.g. ball-bearing mounted, or as a moveable positive-fit connection, e.g. dovetail), that is set at the distance in the direction of the mirror box and which, if necessary, can be clamped or braked to the desired position. This function of variably changing the distance between the camera unit and the mirror box is required to be able to assemble lenses of different dimensions. The setting of the distance can be carried out manually or it can be done by motors. The motors can be triggered through a computer unit that secures the adjusted distance using previously stored values or live by calibrating the lenses by analysing one or both of the video visuals/signals.

To change the lens or to clean the front lens, the camera carrier running on bearings on the guide can be released or disconnected from the unit that is connected to the spindle or the motor, and travelling on the guide it can be very quickly manually moved in the opposite direction of the mirror box and, if necessary, once again connected to an end position here so that it is locked. If required, this can also be done additionally by brakes on the camera carrier that block it on the guide or on the complete device. This device facilitates the lens change since the calibrated end position can be exactly returned to again after the lens has been changed, whereby the distance usually does not have to be recalibrated. Using a counter can make it easier to find the right distance from the mirror box. When the camera carrier drives backwards with the aid of the motor, the respectively calibrated position can be stored in a computer unit, the carrier can be moved away from the mirror box at the touch of a button and, after the lens has been changed or the front lens has been cleaned, it can be moved to the stored position again. Particularly with a camera or cameras that have to be moved against the force of gravity, a counter spring system adapted to the weight of the individual camera(s) and the superstructures can simplify the moving of the camera or the cameras and of the carrier against the force of gravity.

The user can trigger all the motors either by hand from the periphery of the device, or decentralised by cable or radio control. At the same time, a small mobile control unit can also be used, e.g. a control device linked up by W-Lan or Bluetooth (e.g. iPhone, iPad or Subnotebook) that can control at least one motor using adapted software and a user interface. Data used to trigger at least one motor can also be stored there. Likewise, controls that are performed from a central location by hand or by cable, radio control or another transmission method can also be carried out (e.g. from a control room with the corresponding image monitoring equipment, e.g. monitors suitable for 3-D images).

If several camera mountings are being used (e.g. during a multi-camera operation), an operator can either activate each camera mounting with an individual control device or with individual operating elements or switch between the camera mountings or motors within a camera mounting and control it by always using at least only one operating element.

The motors can be controlled either automatically through a computer unit or a control unit (decentralised at the camera mounting or, if necessary, centralised for several camera mountings simultaneously). Here the control unit can control the motors on the basis of an algorithm (e.g. the interaxial or the convergence setting of the camera). The values required for this procedure are either stored in the control unit (e.g. through a previous calibration or adjustment procedure), or they are entered by the user or by the equipment that is being used (e.g. reading out the lenses—e.g. focus and camera distance) during the actual operating time, or they are obtained by additional equipment (distance measurement through laser, ultrasonics, triangulation, auxiliary cameras or an analysis of one or several picture contents taken live).

As an alternative, calibration values for the calibration motors or adjustment values for the motors that change the three-dimensional effect of the picture can also be obtained through algorithms that analyse the picture and, if necessary, through limits that are set by the user and readily used to control the motors. For this purpose, the picture correspondence required for determining calibration errors (vertical errors, rotational errors, tilting errors, etc.) or other adjusting parameters (interaxial) can be used. Alternatively, the user may also manually mark partial image areas or correspondence points (e.g. distant points, screen plane or near points) in at least one of the pictures produced by the camera or through a user interface that can be used to calibrate or to adjust the three-dimensional parameters. To make it easier to define image correspondences, other aids such as patterns or marks that are easily recognisable on the image signals and that help the search for correspondence through the algorithm or that can be recognised easier by a distance metre can also be introduced.

At the same time the user can intervene at the controls of the motors at any time through a user interface and, if necessary, set user-specific limits or carry out a whole or partial manual control. The parameters and the information on the quality of the calibration, the later effect of the three-dimensional film on the viewer, or also the limits of the three-dimensional view or other useful information or recommendations can be presented to the user on a display or another user interface. In all cases, all parameters can be saved separately or deposited together with the video visual as metadata for a later control or a later combination of the real picture content with, for example, computer generated content (so-called CGI-Compositing), e.g. with the current time code, another piece of information or picture content provided by a piece of equipment or another piece of information entered by the user. To combine real pictures with miniature pictures (e.g. 1:5), the recorded metadata can be automatically converted to the miniature scale and used accordingly to adjust the camera mounting to the miniature scale.

Likewise all the limits or settings (e.g. the screen plane, the near and distant point, the beam of light of the picture visible by the lens) can be displayed at a user interface or at the set. This enables the preference parameters and the limits for the operator and/or for the people and actors involved in taking the shots to be displayed in the object space (film set). This can, for example, include a projection of the portrayable limits or of the screen plane in the object space or a visualisation at a Monitor/Head-Mounted-Display (HMD). This can be done through a projection in the set (e.g. when a laser mounted on to a tripod automatically calculates its height and through the geometrical calculations changes the angle of a widely radiating laser pointer according to the distance). This can also be arranged in a manner that is not visible from the camera taking the pictures. An example would be a projection in the film set where “forbidden” picture elements have been marked (e.g. marked in colour). This mark can be faded out for the real picture or shown in wavelength ranges that are visible to the human eye but hidden from the camera through band-elimination filters. An alternative to this would be a projection system that is synchronised with the cameras through, for example, a generator locking device that uses the filming breaks (e.g. blanking intervals between two pictures) to project certain areas in the filming space at exactly this moment and to turn this function off in time for the camera to take a new picture. With this the marked and projected areas would appear to have been displayed for the integral perception of the human eye, whereas they would be hidden to the cameras that are taking the three-dimensional pictures. Alternatively, these areas can be shown on a monitor or a HMD-visualisation system.

1-36. (canceled)

37. A device for taking three-dimensional images comprising:
a frame including at least one guide;
a mirror box linked to the at least one guide to permit translation of the mirror box thereon;
a partial mirror fixedly mounted to the mirror box;
first and second cameras positioned on the frame, each having an optical axis establishing a beam path that is oriented towards the mirror box wherein the respective beam paths are orthogonal to each other;
whereby translation of the mirror box spatially modifies the beam path of only one camera.

38. The device of claim 37 further comprising adjustment means for translating the mirror box.

39. The device of claim 38 wherein the adjustment means comprises one of a motor drive, a piezo drive, a magnetic element or a magnetic drive.

40. The device of claim 38 wherein the adjustment means is responsive to a computing device.

41. The device of claim 37 wherein at least one camera is translationally mounted to the frame to modify the distance between the at least one camera and the mirror box.

42. The device of claim 41 further comprising at least one motor for translating the at least one camera.

43. The device of claim 39 wherein the adjustment means is responsive to a calculating algorithm operatively running on a computing device coupled to the adjustment means and the computing device receiving electronic input from the first and second cameras.
